(19) United States
(12) Patent Application Publication
(10) Pub. No.: US 2014/0320026 A1
(43) Pub. Date: Oct. 30, 2014

(54) LIGHTING DEVICE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: LONG ZHAO, Wuhan (CN); HUI ZHU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/217,260

(22) Filed: Mar. 17, 2014

(30) Foreign Application Priority Data
Apr. 24, 2013 (CN) 2013101444344

(51) Int. Cl. H05B 33/08

(52) U.S. Cl. CPC H05B 33/0854
USPC 315/155

(57) ABSTRACT

A lighting device includes a lighting unit, a control unit, and a brightness adjusting unit connected between the control unit and the lighting unit. The brightness adjusting unit includes an operational amplifier and a number of branch circuits parallel connected between the control unit and a positive input terminal of the operational amplifier. Each branch circuit includes a diode and a photoresistor. A reference voltage is applied to an inverting input terminal of the operational amplifier. The operational amplifier compares a voltage on the positive input terminal and the reference voltage, and output a voltage via an output terminal to the lighting unit according to a comparing result. The control unit further controls the diode to switch between a turned on state and a turned off state to adjust the sensitivity of the lighting device in response to user input.

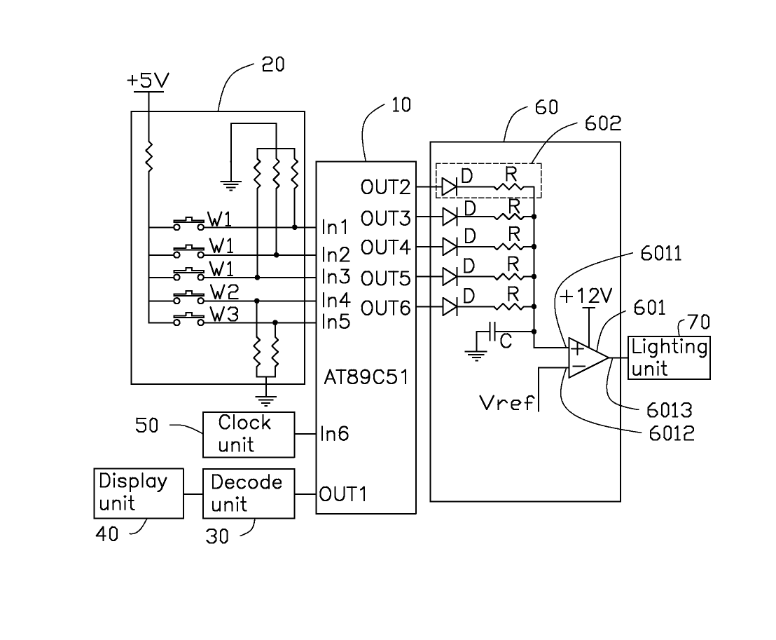

### BACKGROUND

1. Technical Field

The present disclosure relates to lighting devices, and particularly to a lighting device capable of automatically adjusting brightness according to ambient luminance.

2. Description of Related Art

A lighting device usually emits light in a fixed brightness. The fixed brightness may be not fit with a requirement of an environment, and peoples may feel uncomfortable.

Therefore, what is needed is a lighting device capable of automatically adjusting brightness according to ambient luminance to solve the above-mentioned problem.

### BRIEF DESCRIPTION OF THE DRAWINGS

Many aspects of the present disclosure should be better understood with reference to the following drawing. The components in the drawing are not necessarily drawn to scale, the emphasis instead being placed upon clearly illustrating the principles of the present device. Moreover, in the drawing, like reference numerals designate corresponding components throughout the views.

The FIGURE is a circuit diagram of a lighting device capable of automatically adjusting brightness according to ambient luminance, in accordance with an exemplary embodiment.

### DETAILED DESCRIPTION

Embodiments of the present disclosure are described with reference to the accompanying drawing.

The FIGURE shows an exemplary embodiment of a lighting device 100 capable of adjusting brightness according to ambient luminance automatically. The lighting device 100 includes a control unit 10, an input unit 20, a decoding unit 30, a display unit 40, a clock unit 50, a brightness adjusting unit 60, and a lighting unit 70. In this embodiment, the lighting unit 70 may include at least one light-emitting diode, or at least one incandescent bulb, for example. In this embodiment, the control unit 10 is AT89C51 microcontroller. The control unit 10 includes a number of input ports and a number of output ports. In this embodiment, the control unit 10 includes five data input ports In1-In5, a clock input port In6, a display output port OUT1, and five output ports OUT2-OUT6. In other embodiments, the number of data input ports and the number of output ports can be set as needed.

The input unit 20 is electrically connected to the control unit 10 via the data input ports In1-In5 and is used to receive user input. The control unit 10 is used to set a time period according to user input received by the input unit 20. If the lighting unit 70 is turned on to emit light in the time period, the lighting unit 70 then automatically adjusts the brightness according to ambient luminance during the time period. The control unit 10 is used to control the lighting unit 70 to adjust the brightness according to the set time period automatically. For example, suppose the set time period is from 6:00 AM to 19:30 PM, when the lighting unit 70 is turned on to emit light within the time period, the control unit 10 controls the lighting unit 70 to adjust the brightness according to ambient luminance automatically. In addition, when the lighting unit 70 is turned on to emit light out of the time period, the control unit 10 controls the lighting unit 70 to emit light in a fixed brightness. In this embodiment, the input unit 20 includes a number of buttons W1 provided for producing user input including setting the time period. Then the control unit 10 may set the time period according the user input by a well known technology. In an alternative embodiment, the input unit 20 may be a remote controller. In other embodiment, the input unit 20 may be a touch input device.

The decoding unit 30 is electrically connected to the display output interface OUT1. The decoding unit 30 receives a signal corresponding to the time period set according to the user input, and decodes the signal to output a decoded signal. In this embodiment, the decoding unit 30 is a chip with a model type 74LS138.

The display unit 40 is connected to the decoding unit 30 and is used to receive the decoded signal from the decoding unit 30, and display the time period set by the user according to the received decoded signal.

The clock unit 50 is electrically connected to the control unit 10 via the clock input port In6. The clock unit 50 provides a clock signal to the control unit 10. In this embodiment, the clock unit 50 is a chip with a model type DS1302.

The brightness adjusting unit 60 is used to detect the ambient luminance and control the lighting unit 70 to adjust the brightness according to the ambient luminance when the lighting unit 70 emits light within the time period, under the control of the control unit 10.

In this embodiment, the brightness adjusting unit 60 is connected to the control unit 10 and under the control of the control unit 10. The brightness adjusting unit 60 includes an operational amplifier 601 and a number of branch circuits 602. The operational amplifier 601 includes a non-inverting input terminal 6011, an inverting input terminal 6012, and an output terminal 6013. The branch circuits 602 are connected between the control unit 10 and the non-inverting input terminal 6011 of the operational amplifier 601 in parallel. In this embodiment, the brightness adjusting unit 60 includes five branch circuits 602, and each branch circuit 602 includes a diode D and a photoresistor R. The photoresistor R is a light-controlled variable resistor. In the embodiment, a resistance value of the photoresistor R is inversely proportional to the ambient brightness. The anode of the diodes D are respectively electrically connected to the output ports OUT2-OUT6. The cathode of each diode D is connected to the non-inverting input terminal 6011 of the operational amplifier 601 via the photoresistor R. The inverting input terminal 6012 of the operational amplifier 601 receives a reference voltage V_{ref}. In the embodiment, the inverting input terminal 6012 of the operation amplifier 601 connects to a power source (not shown) and obtains the reference voltage V_{ref}. The output terminal 6013 of the operational amplifier 601 is connected to the lighting unit 70. The operational amplifier 601 is used to compare the voltage input from the non-inverting input terminal 6011 with the reference voltage V_{ref}, and output a voltage V to the lighting unit 70 via the output terminal 6013 according to the compared result. In this embodiment, the reference voltage V_{ref} is equal to a minimum value of a voltage input to the positive input terminal 6011.

In the embodiment, the greater a difference between the voltage of the non-inverting input terminal 6011 and the inverting input terminal 6012, the smaller the voltage V output by the output terminal 6013. Because the voltage of the reference voltage V_{ref} is a fixed value, the voltage of the non-inverting input terminal 6011 determines the difference between the voltage of the positive input terminal 6011 and the inverting input terminal 6012.

In this embodiment, the brighter the ambient luminance, the smaller the resistance value of the photoresistor R, and the greater the voltage input to the positive input terminal 6011. For example, if the ambient luminance is increased, the resistance value of the photoresistors R becomes smaller, thus the voltage input to the non-inverting input terminal 6011 is greater, and the difference between the voltage of the non-inverting input terminal 6011 and the reference voltage V_{ref} of the inverting input terminal 6012 is greater, the output voltage V output by the output terminal 6013 is smaller. That is, the voltage V provided to the lighting unit 70 becomes smaller, and thus the brightness of the light emitted by the lighting unit 70 is decreased. Similarly, when the ambient luminance is decreased, the brightness of the light emitted by the lighting unit 70 is increased.

In this embodiment, the input unit 20 further includes a sensitivity increasing button W2 and a sensitivity decreasing button W3 to adjust a sensitivity of the lighting unit 70 for sensing the ambient luminance. In detail, if the sensitivity increasing button W2 is pressed one time, the control unit 10 controls one of the output ports OUT2-OUT6 to output a digital-high voltage to the corresponding branch circuit 602, thus one corresponding diode D in that branch circuit 602 is turned on, and the photoresistor R in that branch circuit 602 is enabled, therefore the number of enabled photoresistors R is increased, the sensitivity for sensing the ambient luminance is increased.

Similarly, if the sensitivity decreasing button W3 is pressed one time, the control unit 10 controls one of the output ports OUT2-OUT6 to output a digital-low voltage to the corresponding branch circuit 602, thus the diode D in that branch circuit 602 is turned off, and the photoresistor R in that branch circuit 602 is disabled, therefore the number of disabled photoresistors R is reduced, the sensitivity for sensing the ambient luminance is reduced. Thus, the control unit 10 increases the number of the output ports outputting the digital-high voltage and decreases the number of the output ports outputting the digital-low voltage when the sensitivity increasing button W2 is pressed. The control unit 10 decreases the number of the output ports outputting the digital-high voltage and increases the number of the output ports outputting the digital-low voltage when the sensitivity decreasing button W3 is pressed.

Although the present disclosure has been specifically described on the basis of exemplary embodiments thereof, the disclosure is not to be construed as being limited thereto. Various changes or modifications may be made to the embodiments without departing from the scope and spirit of the disclosure.

What is claimed is:

1. A lighting device comprising:
a lighting unit configured to emit light;
a control unit comprising a plurality of data input ports and a plurality of output ports; and
a brightness adjusting unit connected between the lighting unit and the control unit, the brightness adjusting unit being connected to the control unit via the output ports, the brightness adjusting unit comprising an operational amplifier and a plurality of branch circuits connected between the control unit and the operational amplifier in parallel, each branch circuit comprising a diode and a photoresistor; wherein the photoresistor is a light-controlled variable resistor; an anode of each diode is connected to one of the output ports of the control unit, a cathode of each diode is connected to a positive input terminal of the operational amplifier via the corresponding photoresistor; an inverting input terminal of the operational amplifier receives a reference voltage; an output terminal of the operation amplifier is connected to the lighting unit, the operational amplifier compares a voltage of the non-inverting input terminal and a voltage of the inverting input terminal to obtain a comparison result, and outputs a corresponding voltage to the lighting unit via the output terminal according to the comparison result.

2. The lighting device as described in claim 1, further comprising an input unit connected to the control unit via the data input ports; wherein the input unit is used to receive user input to adjust a sensitivity of the lighting unit for sensing an ambient luminance; the control unit controls a voltage of one output port that outputs to the branch circuits switches between a digital-high voltage and a digital-low voltage according to the user input, thus causing the diode connected to the output port in the branch circuits switches between a turning on state and a turning off state, thus the photoresistor connected to the diode switches between an enable state and an unable state.

3. The lighting device as described in claim 1, wherein the brighter the ambient luminance, the smaller a resistance value of the photoresistor R, and the greater a voltage inputted to the non-inverting input terminal of the operational amplifier.

4. The lighting device as described in claim 1, wherein the reference voltage provided to the inverting input terminal of the operational amplifier is equal to a minimum value of a voltage inputted into the non-inverting input terminal of the operational amplifier, and the greater a difference between a voltage on the non-inverting input terminal and the reference voltage on the inverting input terminal, the smaller the voltage outputted by the output terminal.

5. The lighting device as described in claim 2, wherein the input unit comprises a sensitivity increasing button and a sensitivity decreasing button to adjust a sensitivity of the lighting unit for sensing the ambient luminance; if the sensitivity increasing button is pressed for one time, the control unit controls one of the output ports to output a digital-high voltage to the corresponding branch circuit, thus causing one corresponding diode in that branch circuit is turned on, and the photoresistor in that branch circuit is enabled, therefore the number of enabled photoresistors is increased, the sensitivity for sensing the ambient luminance is increased; if the sensitivity decreasing button is pressed for one time, the control unit controls one of the output ports to output a digital-low voltage to the corresponding branch circuit, thus causing one corresponding diode in that branch circuit is turned off, and the photoresistor in that branch circuit is unable, therefore the number of unable photoresistors is reduced, the sensitivity for sensing the ambient luminance is reduced.

6. The lighting device as described in claim 2, wherein the input unit comprises a plurality of buttons provided for producing user input comprising setting a time period, if the lighting unit is turned on to emit light in the time period, the lighting unit then automatically adjusts the brightness according to ambient luminance during the time period.

7. The lighting device as described in claim 6, further comprising a decoding unit, a display unit and a clock unit, wherein the decoding unit is used to receive a signal corresponding to the time period set according to the user input, and decode the signal to output a decoded signal; the display unit is connected to the decoding unit and is used to receive the decoded signal from the decoding unit, and display the time period set by the user according to the received decoded signal; and the clock unit is electrically connected to the control unit via a clock input port of the control unit, the clock unit provides a clock signal to the control unit.

8. The lighting device as described in claim 7, wherein the control unit is a chip with a model type AT89C51, the clock unit is a chip with a model type DS1302, and the decoding unit is a chip with a model type 74LS138.

9. The lighting device as described in claim 2, wherein the input unit is a remote controller.
